(19) United States
(12) Patent Application Publication
(10) Pub. No.: US 2015/0231506 A1
(43) Pub. Date: Aug. 20, 2015

(54) CELEBRITY VIDEO GAMING NETWORK

(71) Applicant: Sony Computer Entertainment America LLC, San Mateo, CA (US)

(72) Inventors: Jonathan Webb, Sausalito, CA (US); Misako Usui, San Jose, CA (US); Joan Moriyama, Oakland, CA (US); John Koller, Dublin, CA (US); Gavin Howell, Hayward, CA (US)

(73) Assignee: Sony Computer Entertainment America LLC, San Mateo, CA (US)

(21) Appl. No.: 14/184,622

(22) Filed: Feb. 19, 2014

(51) Int. Cl. A63F 13/79; A63F 13/35

(52) U.S. Cl. CPC A63F 13/79; A63F 13/35

(57) ABSTRACT

A plurality of general public video game users are notified of an online celebrity gaming match. The match has at least one celebrity participant. A request to participate in the online celebrity gaming match is received from at least some of the general public video game users. At least one of the requesting users is selected for participation in the online celebrity gaming match. Interactive access to the celebrity gaming match through authentication with a corresponding user account for each of the participants selected from the general public. Access for each celebrity participant is authorized through authentication with a corresponding celebrity user account. Each celebrity user account is restricted to a verified celebrity whose celebrity identity has been previously verified.

### FIELD

Aspects of the present disclosure relate to online video game networks. In particular, aspects of the present disclosure relate to online multiplayer gaming having one or more celebrity participants.

### BACKGROUND

Recently, video gaming has evolved from a mostly single player experience to a massive online community which connects players across cities, states, and even internationally. Video games provide a platform not only for joining together different users for competitive and cooperative gaming, but also an outlet for joining together users socially who have a common passion for video gaming.

Traditionally, video gaming has remained fairly segregated from other forms of entertainment and consumer media, such as movies, television show, sports, and the like. Some attempts have been made to recently expand and integrate certain consumer media content into the video gaming experience. For example, some video game platforms provide user access to television shows and other consumer media through the video game platform itself. However, these traditional approaches are mostly confined to integrating existing features into a video game computer system in a fairly conventional manner, doing little to expand respective entertainment experiences in new or creative ways. Moreover, these traditional approaches do little to connect video game users to other members of the entertainment community.

It is within this context that aspects of the present disclosure arise.

### BRIEF DESCRIPTION OF THE DRAWINGS

The teachings of the present disclosure can be readily understood by considering the following detailed description in conjunction with the accompanying drawings, in which:

FIG. 1 is a schematic diagram depicting an illustrative example of a network connecting various entities in accordance with certain aspects of the present disclosure.

FIG. 2 is a schematic diagram depicting an illustrative example a celebrity gaming match in accordance with certain aspects of the present disclosure.

FIG. 3 is a flow diagram depicting an illustrative example of a celebrity gaming match in accordance with certain aspects of the present disclosure.

FIGS. 4A-4D are schematic diagrams of an illustrative example of a celebrity gaming lobby having a plurality of gaming matches in accordance with certain aspects of the present disclosure.

FIG. 5 is a schematic diagram of a computing system that may be configured to implement one or more features associated with an online celebrity gaming network in accordance with certain aspects of the present disclosure.

### DETAILED DESCRIPTION

Although the following detailed description contains many specific details for the purposes of illustration, anyone of ordinary skill in the art will appreciate that many variations and alterations to the following details are within the scope of the invention. Accordingly, the illustrative implementations of the present disclosure described below are set forth without any loss of generality to, and without imposing limitations upon, the claimed invention.

### Introduction

Aspects of the present disclosure relate to online gaming features that may be specially tailored to the hosting of online multiplayer matches involving celebrities. In particular, implementations of the present disclosure may provide an online gaming platform that facilitates online gaming matches which have one or more verified celebrities as participants in the gaming sessions along with one or more members of the general public. Each verified celebrity may be a celebrity whose celebrity identity has been previously verified, e.g., an entity managing or providing the gaming platform. This may allow fans and celebrities to interact with one another in a variety of ways that are not possible with other traditional entertainment platforms, including conventional gaming, conventional social media, and other conventional entertainment platforms.

Furthermore, in certain implementations of the present disclosure, celebrity gaming may involve celebrities and members of the general gaming public who participate in online multiplayer gaming not only as players, but in other unique ways.

To support online celebrity gaming in accordance with aspects of the present disclosure, various participants in the celebrity gaming matches may be granted authorization to participate through authentication through one or more user accounts. In certain implementations, to provide a unique online gaming platform, celebrities may participate in an online video game platform and in celebrity gaming sessions through special celebrity user accounts, and access to celebrity user accounts may be restricted to only verified celebrities. Furthermore, in certain implementations authentication with a special celebrity account may provide a celebrity gaming user access to features unavailable to the general public gaming users. In some implementations, a celebrity account may have security features that prevent the celebrity's account information from being made known to other users. By way of example, a celebrity account may be configured in such a way that the celebrity's gaming network ID or username is kept secret from other public users. The system may be configured to that the celebrity's ID is provided on a “need-to-know” basis, e.g., to the system belonging to the user selected to play against the celebrity, and to others who need to know the ID. However, the celebrity user's gaming network ID may be kept secret from such entities until such time as they need to know it. A celebrity account may also be configured to verify to a user playing against the celebrity (e.g., a general public user playing against the celebrity user) that the celebrity is really playing against the lucky user.

In yet further implementations, proceeds generated from the celebrity online gaming session may be donated to one or more non-profit entities, thereby channeling passion exhibited by the gaming community to charitable causes and utilizing aspects of video gaming networks for social good.

Implementation Details

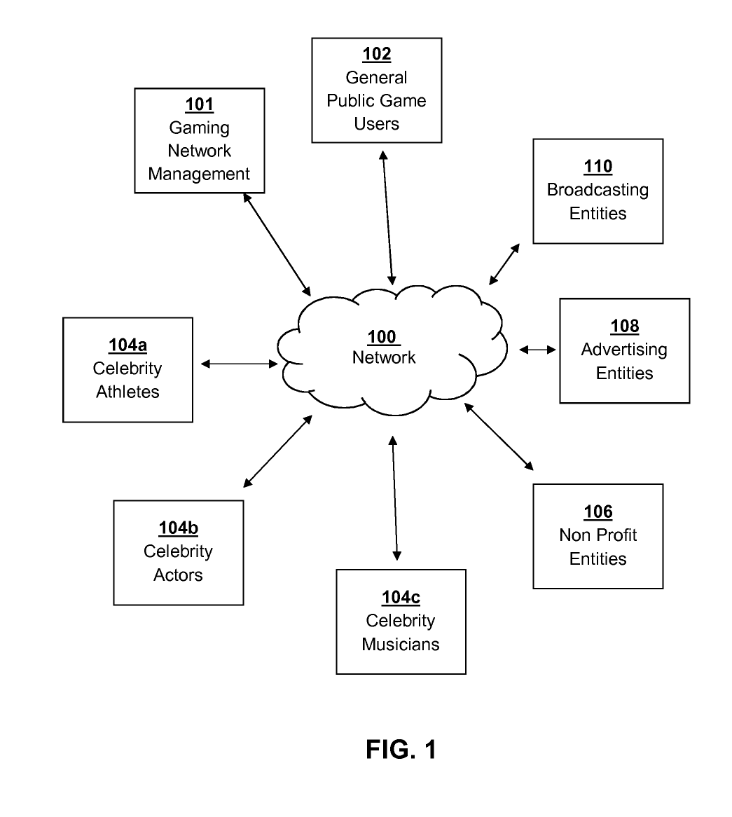

Turning to FIG. 1, an illustrative example of certain aspects of a gaming platform configured to facilitate online celebrity gaming is depicted. In the example shown in FIG. 1, certain entities relevant to a celebrity gaming platform are depicted, although it is noted that the entities depicted in the drawing of FIG. 1 is non-exhaustive and there may be other entities.

An online gaming network 100 may be associated with one or more video game platforms, such as a video game console platform, a handheld console platform, a PC gaming platform, mobile device platform (i.e., mobile apps for smart phones, tablet computers, smart watches, and the like), or any combination thereof. Access to the online gaming network may be available through a telecommunications network, such as the internet, and the online gaming network may support multiplayer gaming play between various users located remotely from one another and connected to the network. The online gaming network may also optionally support a variety of other digital media and entertainment features, such as video streaming, music streaming, social networking, and the like. Access to the gaming network may be controlled through a gaming network manager 101, which may be a specialized computer server configured, e.g., to implement account setup, account verification, match players for gaming sessions, manage servers that implement multiplayer online gaming sessions, provide for download and update of gaming software for video game platforms that are connected to the network 100, and/or other features in support of online gaming in accordance with aspects of the present disclosure.

In accordance with certain aspects of the present disclosure, the online gaming network 100 may allow participation not only by members of the general public 102, but also by celebrities 104a-c in a variety of interest areas. It is noted that while traditional gaming networks are generally open to celebrities in the same manner that they are open to any ordinary member of the general public, they typically do nothing to distinguish celebrity users from any other general public users. As a result, traditional online gaming fails to effectively utilize celebrity fame and increase user interest from members of the general public. Moreover, traditional online gaming does a poor job of connecting the celebrities to their fans and members of the general public.

In certain implementations of the present disclosure, access to the online video game network may be authorized for the celebrities in a manner that distinguishes them from members of the general public within the operation of the gaming network itself. For example, each user of the online gaming network may connect to the network through an authentication process involving a corresponding user account for the user. While the members of the general public may access the network through authentication with an ordinary, general public user account, each celebrity participant 104a-c may be associated with a specialized celebrity user account, and authentication with the special celebrity user accounts may be restricted to only verified celebrities. The celebrity users may also be identified to the other users via a celebrity identifier that is included as part of a user profile for the celebrity account. For example, there may be one or more special badges or other icons which could be included in a user profile image of the celebrity user account, which may indicated to the other users that the user account belongs to a verified celebrity.

In accordance with certain aspects of the present disclosure, each celebrity user account may be distinguished from the general public user accounts throughout the online gaming platform, and the distinction may facilitate a variety of unique celebrity gaming features that may provide a more interesting and engaging experience for the users that is not possible with traditional platforms. For example, the online gaming network may provide a unique and robust platform for connecting celebrities with their fans through the general public fans' interest in video games. The presence of the celebrities, who may be identified and distinguished among the other users of the gaming network through their restricted celebrity user accounts, may generate increased interest in the online gaming network, as well as provide a direct social connection between the general public and the celebrities who participate in the online gaming network. In certain implementations, the celebrities' presence may be indicated to various members of the general public throughout an online gaming platform in a specialized manner that is distinct from ordinary members of the general public. For example, when a celebrity user account is logged into the gaming network, the celebrity's presence may be indicated to the general public by prominently displaying the celebrity user in a gaming network home screen, menu or sub-menu of the gaming network, an online gaming lobby, menu or selection in particular gaming titles, or in some other manner that indicates to the general that the celebrity is online. Moreover, in some implementations, the celebrity account may provide the celebrity user with the ability to make such availability public to engage with fans, or otherwise hide the celebrities' presence in some manner so that the celebrity may enjoy online gaming in a normal manner if the celebrity does not wish to engage fans at a particular time, yet wishes to enjoy the gaming platform. The celebrities depicted in FIG. 1 may include one or more celebrities from a variety of different interest areas, including celebrity athletes 104a, celebrity actors 104b such as television and movie actors, celebrity musicians 104c, and/or other celebrities (not pictured), such as internet celebrities, celebrity developers (such as game developers), professional gamers (such as competitive gaming tournament winners), professional game commentators, and the like. It is noted that celebrities are not limited to the specific examples described herein, but may instead include a variety of different types of persons who are known to the general public for a variety of different interest areas, including, but not limited to, sports, music, politics, business, religion, fashion, socialites, journalists, gaming itself, and other known persons. In some implementations, the celebrities may be distinguished in certain aspects of the gaming network based on their interest area. For example, celebrity athletes 104a logged in to the network through a corresponding celebrity account may be displayed exclusively or more prominently to users playing sports games, celebrity actors 104b logged in to the network may be displayed exclusively or more prominently to users playing games involving characters portrayed by the actors 104b, celebrity musicians 104c logged in to the network may be displayed exclusively or more prominently to users playing music games, e.g., rhythm games which are played by dancing or playing a virtual instrument.

Moreover, in certain implementations, the presence of the celebrities in the online gaming network may be used to generate proceeds for charitable causes and social good. For example, as shown in FIG. 1, the gaming network may involve one or more non-profit entities 106, and a celebrity presence throughout the online gaming network may be used to generate proceeds for donation to the non-profit entities 106.

In some implementations, this may be accomplished by using an online “sweepstakes” system, in which general public users are entered into a sweepstakes whenever they make a qualifying purchase, e.g., for a physical or virtual good from an online store associated with the gaming network. For example, sweepstakes entry and/or opportunities to participate in celebrity gaming matches may be associated with a digital store. For example, a general public user may access a digital content store associated with the online gaming network and purchase different digital goods, such as avatars, themes, game add-ons, and/or other digital content items. In certain implementations, purchasing such digital goods may also provide the user with an entry into a sweepstakes for a change to participate in the celebrity gaming match. Moreover, in certain implementations, some or all of the proceeds generated from such digital content purchases may be consolidated and donated to one or more non-profit entities 106. In some implementations, a digital store may also include physical goods which may be ordered online through the digital store.

One or more of the users entered into the sweepstakes may then be selected for participation in the online celebrity gaming match according to some selection criteria. In certain implementations, the selection criteria may simply be a random selection from among those entered into the sweepstakes. In some implementations, as an alternative to, or in addition to, entry via qualifying purchases, general public users may be entered into the sweepstakes for free, simply upon making a request for entry, e.g., via a submission request through an online interface for the gaming network. A free submission for entry into the sweepstakes may be, e.g., a written submission of the user's network account information.

In some implementations, provided gambling laws of the relevant jurisdiction permit, generating proceeds via celebrity participation in the gaming network may be accomplished by using an online raffle system, in which general public video game users pay money or provide some other form of compensation solely for online “raffle tickets” in order to get an opportunity to participate in a gaming match with a celebrity. Some or all of the compensation provided by the video game users may then be donated to the one or more non-profit entities 106. One or more of the users who request to participate in the celebrity gaming match, e.g., by purchasing “raffle tickets” or by providing compensation for the opportunity to participate, may then be selected to participate in the celebrity gaming match according to some selection criteria, which may be random in the style of a raffle or may be some other selection criteria. In some implementations, the likelihood that a user will be selected may be weighted based on one or more criteria. For example, the video game users' skill, loyalty to gaming platform as indicated by frequency/amount of time spent playing, or some other criteria may be used to assign weights to the opportunities to participate in online celebrity gaming matches, e.g., to incentivize or reward certain behaviors in the gaming platform. Players who spend more time playing, players exhibiting greater skill, or other criteria, e.g., as indicated by statistics associated with the user's account or a metagame status of the user's account, may be assigned a greater weight in a selection process for participation in the celebrity gaming matches. This may be beneficial, e.g., to foster competition among the gaming community and engender loyalty to gaming network.

In some implementations, raffle tickets may be purchased by redeeming points earned through game play in a metagame rewards system. An example of a metagame rewards point system having points which can be redeemed for raffle tickets in implementations of the present disclosure is described in U.S. patent application Ser. No. 13/960,673 to Eric Lempel et al., filed Aug. 6, 2013, entitled “METAGAME REWARD POINT SYSTEM”, the entire contents of which are herein incorporated by reference. In some implementations, metagame points acquirable across gaming titles, e.g., as described in that document, may be redeemed directly in exchange for participation in celebrity gaming matches (i.e., not just a raffle ticket opportunity).

In some implementations, a metagame status, such as metagame point totals associated with the metagame reward point system as described in that document or some other metagame status that is acquirable across different gaming titles may be utilized as criteria in the selection process used to select participants in the celebrity gaming matches

In certain implementations, users may able to sponsor others for charity by purchasing raffle tickets in their name (proceeds of which may be donated to the non-profit entities), or by donating money directly to the non-profit entities in honor of the celebrity vs. lucky user match. In certain implementations, this may be accomplished through an interface maintained in the online network which allows general public user accounts to purchase raffle tickets or goods, and request participation in the celebrity gaming match for a different user account in exchange.

In yet further implementations, proceeds may be generated for charitable causes through advertising revenue generated by the celebrity presence in the online gaming network, e.g., in advertisements integrated into celebrity gaming lobbies or other locations throughout the online gaming network. Such advertising may be provided by advertising entities 108.

In certain implementations, a non-profit entity receiving proceeds generated through online celebrity gaming may be a charity selected by a celebrity involved in the gaming match. It is noted that utilizing the celebrity presence to generate proceeds for charitable causes may not only provide a social good, but may also provide increased incentive for the celebrities to participate in the online gaming network.

In some implementations, broadcasting entities 110 (e.g., television networks or online video streaming providers) may be connected to the network 100 to broadcast the online celebrity gaming session to a plurality of general public spectators. It is noted that, in some implementations, broadcasting of online gaming matches may be performed at least partially within the online gaming network itself, by authorizing access to an audio/video feed of celebrity online gaming matches to video receiving devices, e.g., video game systems or other internet connected devices, which are authenticated with a user account of the online video game networks.

In some implementations, broadcasting the celebrity gaming match may involve not only broadcasting the in-game content, i.e., a feed of the video/audio output of the game that is presented to the players, but may also include a live video and/or audio feed of the game players themselves. For example, in some implementations, a camera may capture video of the celebrity participants, general public participants, or a combination thereof, and video of these players themselves may be broadcast so that viewers may see them instead of, or in addition to, the feed of the game content. This may also be useful in providing proof to the general public that the celebrity participant really is the celebrity it is supposed to be.

In some instances, this may be a webcam or other camera that is a peripheral of the computing device which provides the gaming platform for the game involve, e.g., may be a webcam peripheral of a home game console. In other instances, the video may be captured with a camera that is independently set up at the location of the participant and dedicated to the event of the game.

It is noted that a video/audio feed of a celebrity gaming match may be delivered to users for viewing in real-time or at a later date, e.g., by broadcasting in real-time, by recording and storing the feed for later viewing, or some combination thereof.

In certain implementations, videos of gameplay and/or videos of the celebrities and general public users, could be created, edited, and/or uploaded to storage for users to be able to watch after the match, e.g., by accessing the video online. By way of example, and not by way of limitation, a video may include both video of the gameplay, as well as video of one or more of the players or participants, using picture in picture. In some implementations, a video may be able to be edited by users. In some implementations, videos of a celebrity gaming match may created, edited, and uploaded automatically, e.g., by a server or gaming network management system.

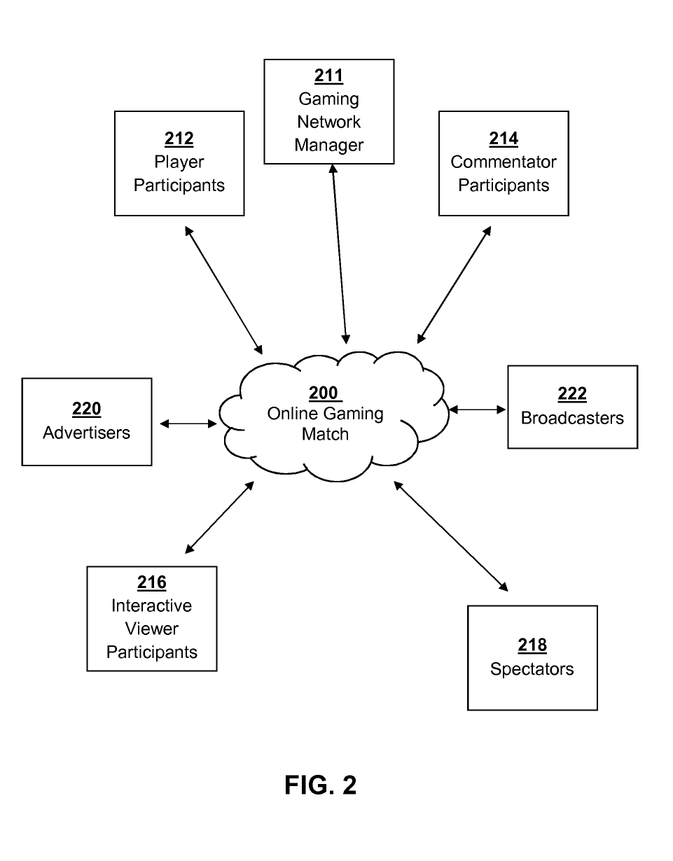

Turning to FIG. 2, an illustrative example of a celebrity gaming match involving a plurality of users is depicted. It is noted that each of the users illustrated in FIG. 2 may be a celebrity user or a general public user in various implementations of the present disclosure. Moreover, each of the users involved in the celebrity gaming match may be remotely located with respect to one another and may access the celebrity gaming match over a network connection, such as the internet. The celebrity gaming match may be managed by a Gaming Network Manager 211.

In certain implementations of the present disclosure, each of the users may be involved in the online celebrity gaming match via authentication through a corresponding user account. For example the users involved in the gaming match depicted in FIG. 2 may include general public users who are authenticated for the celebrity gaming match through corresponding general public user accounts of the online gaming network, as well as celebrity users who are authenticated for the celebrity gaming match through corresponding celebrity user accounts, and the celebrity user accounts may be of a user account type that is restricted to verified celebrities and may be unavailable to the general public. In certain implementations, certain features or different functionality may be authorized in the celebrity user accounts that are unavailable to the general public user accounts. For example, such features may optionally include a unique lobby for the celebrities to enter which the general public user is prevented from regularly accessing. In certain implementations, such a unique lobby may facilitate matches where the celebrities play only amongst themselves. Such celebrity features may also optionally include an identifier on the celebrity user account's profile that specifies which verified celebrity identity is behind the corresponding celebrity account. Such celebrity features may also optionally include a special callout on their Rich Profile (status) that specifies who they are. Such features may also optionally include communication options between celebrities. Such features may also optionally include the ability for the celebrity user account to control or limit invitations from the general public users.

Such features may also include priority for the celebrity user account to select a character or team in an online match. This may be useful, for example, if the video game includes a virtual version of the celebrity or celebrity's team in a particular video game, as it may be desirable in some instances for the celebrity to control a virtual version or avatar version of the particular celebrity during multiplayer matches with other users. By way of example, and not by way of limitation, if an online celebrity gaming match involves a sports video game having a virtual version of the celebrity athlete, the celebrity user account verified to correspond to the celebrity athlete may have priority to select control the virtual version of the celebrity athlete during the online celebrity gaming match. By way of further non-limiting example, if an online celebrity gaming match involves a video game that is based on a movie or television show in which a celebrity actor portrays a character, the celebrity user account corresponding to the verified celebrity actor may have priority to select control of the virtual version of the character of the television show or movie during the online celebrity gaming match.

In some cases, celebrity account features can be tailored to particular games involving those celebrities, or otherwise related to an interest area associated with those celebrities. For example, a sports game may be geared to a sport in which the athletes are represented by avatars. If the celebrity is professional athlete in that sport, the Gaming Network Manager 211 may automatically assign the celebrity athlete to play as himself or may give the celebrity first choice to select himself.

In the example of FIG. 2, the celebrity gaming match may be an online multiplayer match having a plurality of player participants 212 who may play a common multiplayer gaming match together. By way of example, and not by way of limitation, the multiplayer gaming match may involve competitive game play, cooperative game play, or some combination thereof. For example, the plurality of player participants 212 may be divided up into a plurality of teams, and each of the plurality of teams may include a plurality of users. Each team may then compete against each other in competitive game play, while each player within a team may cooperate with each other in cooperative game play. A variety of other configurations are possible, in accordance with the features of the particular game involved. It is noted that in certain implementations, gaming matches may having general public players playing cooperatively with celebrity players, competitively against celebrity players, or in some combination thereof. In addition to player participants, the celebrity gaming match may also involve the users of the video game network in a variety of other ways. For example, the celebrity gaming match may optionally include one or more commentator participants 214, which may be celebrity commentators, general public commentators, or some combination thereof. In some implementations, the commentator participants may not participate in the game as players 212, e.g., they may not provide control inputs for characters in the game or directly affect the outcome of the game through game play, but they may instead may provide a communication feed that may be overlaid onto the output of the gaming match or otherwise transmitted to the other users involved with the gaming match. For example, a live communication feed may be input by the one or more commentator participants and added to the gaming match. In various implementations, the live communication feed from the commentator participants 214 may be an audio feed, a video feed, a text input feed, or some combination thereof. In certain implementations, the communication feed may be provided in the gaming match live and in real time.

In further examples, the celebrity gaming match depicted in FIG. 2 may also optionally include a plurality of non-player participants who are not players in the game, but who still have some effect on the game. This type of non-player participant will hereinafter referred to as interactive viewers 216, and includes non-player participants who are granted some a form of interactive access to the game, but have less direct influence on the game than player participants. In particular, the interactive viewers 216 may not provide control inputs for characters within the gaming match or directly affect the outcome of the gaming match through game play; however, they may be able to influence the game in other ways. By way of example, and not by way of limitation, they may drop items in the game for the player participants, speed up or slow down certain aspects of the game, manipulate the environment of the game, or in some other way affect an environment or other gaming parameter of the game without directly participating as a player.

In yet further examples, the celebrity gaming match may also involve spectators 218, who do not participate in the celebrity gaming match, but may instead merely observe an audio and/or video stream of the game, and the celebrity gaming match may be broadcast to the plurality of spectators 218. Note that these spectators may not be considered “participants” in the celebrity gaming match because they are not granted interactive access to the match itself, although they may be provided with video and/or audio to observe. In certain implementations, a spectator stream may not be restricted to members of the gaming network, but may instead be made publicly available in some other manner, e.g., by broadcast over a television channel or a publicly available internet streaming channel. This may include social interaction among the spectators, as well as viewing after the match has taken place. For example, spectators may be connected for chat or other communication amongst themselves while viewing the match, without having an interactive effect on the match.

In other examples, the celebrity gaming match may involve advertising provided by advertisers 220. Moreover, some or all of the revenue generated by advertising associated with the advertisers 220 may be donated to one or more non-profit entities. In yet other examples, the celebrity gaming match may be broadcast to a wider audience beyond the participants 212 and spectators 218 by one or more broadcasters 222, e.g., television networks, internet streaming networks, and the like.

In certain implementations, it is noted that those players selected as participants in the celebrity gaming match, e.g., via a sweepstakes style selection process as described herein, may be granted interactive access to a celebrity gaming match in a manner that distinguishes them from non-participants. For example, they may be players, commentators, or interactive viewers as described above, allowing them to influence some aspect of a celebrity gaming match. Non-participants, such as pure spectators, may lack such interactive access to the gaming match, although they may, in certain implementations, still be able to view a broadcast of the match if desired. This may be beneficial because there may be a high demand from general public users to participate in celebrity gaming, but it may not be feasible to allow all of the requesting users to participate in a match, e.g., as players or other interactive participants. However, it may still be desirable to engage a wider audience by allowing non-interactive spectators to increase interest in the event and engage a large sector of the general public. This may be accomplished by granting interactive access to the match to only a subset of those requesting users, but still allowing those not selected for participation to be non-interactive spectators, as well as allowing other members of the general public at large to be spectators via broadcasting of the match.

It is further noted that, in certain implementations, a celebrity gaming match may involve setting up a unique lobby using the celebrity account, and having a celebrity user and a general public user play a game together locally, e.g., through a common gaming console. In some implementations, these situations may include an offline multiplayer match between one or more celebrity users and one or more general public users. In some implementations, the celebrity user account may facilitate setting up a special lobby for these situations through which other users may, e.g., spectate and the like from remote locations while the game is played between a celebrity player and a general public player local to each other, e.g., “offline” multiplayer gaming between the players that may be broadcast online to other users.

In some implementations, features associated with the above participants may be integrated for a single user. For example, one or more of the player participants may also be a commentator participant as well as a player participant for the same gaming match.

It is noted that celebrity gaming participants may be integrated into the example gaming match of FIG. 2 in a variety of ways. For example, the gaming match may involve one or more celebrity player participants, celebrity commentator participants, celebrity meta-participants, or some combination thereof. It is noted that be facilitating participation through ways other than as game players, a variety of celebrities who may not otherwise be skilled at video game play may still be involved and connected to the general public through the gaming network, thus increasing the access of the gaming network to the celebrities.

In certain preferred implementations, the gaming match may include both celebrity player participants and general public player participants, so that members of the general public may engage in direct game play with celebrities.

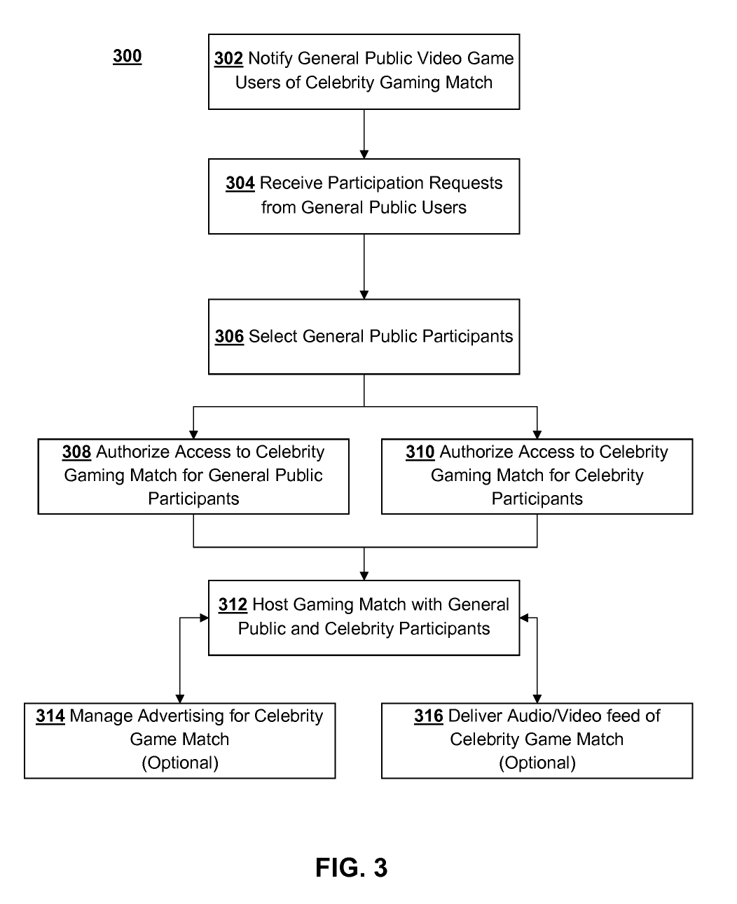

Turning to FIG. 3, an example method 300 for a celebrity gaming match is depicted. Various aspects of the example method of FIG. 3 may be implemented by one or more gaming servers in accordance with aspects of the present disclosure. The gaming servers may be part of the network management 101 of FIG. 1. In some implementations, the gaming servers may include one or more gaming servers dedicated to hosting certain aspects of the method 300 and/or other aspects of the online gaming network as described herein. In further implementations, one or more features of the gaming servers may be hosted in one or more local computing devices, e.g., of one or more of the users participating the online gaming network. In yet further implementations, some combination of the above may be used.

As shown in the example of FIG. 3, a plurality of general public video game users may be notified of at least one online celebrity gaming match, as indicated at 302. The online celebrity gaming match has at least one celebrity participant. As indicated at 304, at least one request to participate in the online celebrity gaming session is received from at least one of the general public video game users.

At least one of the requesting users is selected for participation in the online celebrity gaming session, as indicated at 306.

For example, the method may involve a sweepstakes style selection process as described above. The requesting users indicated at 304 may provide some form of compensation for a physical or digital good, and purchasing the good may enter them in a sweepstakes for an opportunity to participant in the celebrity gaming matches, e.g., as described above. A subset of these requesting users may then be selected to participate in the celebrity gaming match as indicated at 306, e.g., by selecting only a subset of the sweepstakes entries at random, or based on some other criteria, as described above with respect to FIGS. 1 and 2. As another example, in some implementations, no purchase may be required in conjunction with a request to participate in the celebrity gaming match, and the users may simple enter into the sweepstakes for free upon request.

For each of the participants, interactive access to the at least one celebrity gaming match is authorized through authentication with a corresponding user account for each of the participants selected from the general public, as indicated at 308.

Access for each of the celebrity participants is authorized through authentication with a corresponding celebrity user account, as indicated at 310. Each celebrity user account is restricted to verified celebrities. A gaming match may then be hosted with celebrity and general public user participants as indicated at 312.

In order to facilitate engagement between the general public users and the celebrity users, a communication channel between the users may also optionally be established between one or more of the users during the hosting of the gaming match. For example, an audio communication channel, a video communication channel (e.g., webcam type video calls), a text communication channel (e.g., instant messaging), or any combination thereof may be established between the celebrity and general public participants during the hosting of the match. By way of example, and not by way of limitation, a peripheral such as a headset, a webcam, or both may be include at each users device to provide a user interface for the users to communication via a communication channel established during the match.

Advertising may optionally be provided in association with the gaming match, as indicated at 314. For example, the advertising may be integrated within the gaming match, integrated within a gaming lobby having the gaming match, associated with the notification of the celebrity gaming match indicated at 302, or associated with the gaming match in some other manner. A video feed and/or audio feed of the gaming session may also optionally be delivered for viewing by other users in real-time or at a later date by one or more spectators, e.g., by delivering the audio/video feed in real-time through the online gaming network to video receiving devices authenticated with corresponding user accounts, by broadcasting the audio/video feed in real-time to a general audience (e.g., over a television station or internet network streaming service), by recording the audio/video feed for later viewing (e.g., for upload to a media content delivery website), or some combination thereof, as indicated at 316.

In accordance certain aspects of the present disclosure, a celebrity gaming match may be initiated so that a celebrity user account participates in the celebrity gaming match independently from a selection process for selecting general public user account as a participants. For example, the general public user accounts may be required to go through a sweepstakes style selection process, or other selection process that allows only a subset of the requesting general public user accounts to participate or play in the match, while one or more celebrity user accounts associated with the online celebrity gaming match may be automatic players or other participants in the celebrity gaming match, independently from a selection process used for the general public user accounts.

In certain implementations, a variety of other unique features can be incorporated into a celebrity gaming match that is uniquely tailored to the celebrity presence. For example, in some implementations, there may be a fantasy overlay or real-life statistics associated with a celebrity athlete participant in the celebrity gaming match. By way of example, and not by way of limitation, if the celebrity participant is a professional basketball player, professional basketball statistics associated with that professional basketball player may be overlaid onto the celebrity gaming match or otherwise integrated into a celebrity gaming match.

In some implementations, a gaming session may involve competitive gaming having a plurality of celebrities competing against each other. Moreover, in certain implementations, general public video game users may be involved in such celebrity matches without being direct players. For example, the general public users may provide feedback and evaluation of the celebrities performance during these matches, which may fuel competitive instincts in the celebrities and increased competition and interest and amongst the celebrities, e.g., as they compete for fan approval. Moreover, in certain implementations, the general public may be able to identify highlights, e.g., by tagging the highlights in the game for replay, such as in an auto-highlight reel.

In certain implementations, competition amongst celebrities may be used for generate proceeds for a charitable cause. For example, in some implementations, a celebrity gaming match may involve one celebrity buying out an opportunity to play against another celebrity. This may involve a one-time buy to play the celebrity, rather than going through the raffle ticket, sweepstakes, or other selection process.

In some implementations, the general public users may compete for a right to play games with their favorite celebrities. For example, instead of selecting the participating user accounts at random, one or more general public users who request to participate may be matched against each other in a competitive online match for an opportunity to participate in a celebrity gaming match, and selection of the participating users as indicated at 306 may be based on the outcome, e.g., one or more winning users are selected as participants in the celebrity gaming match.

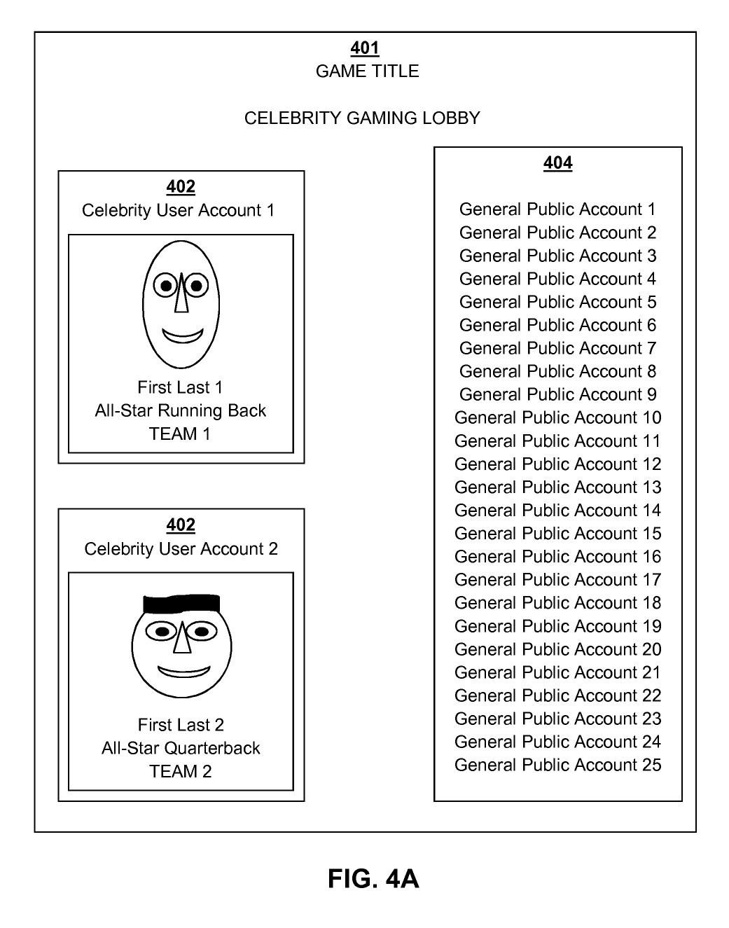

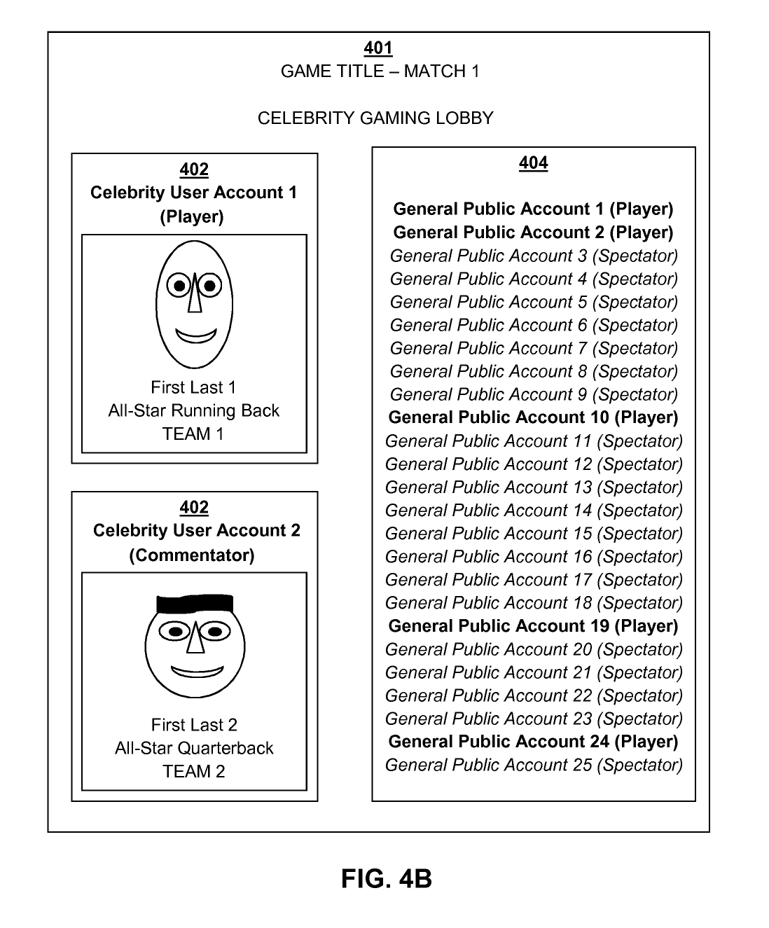

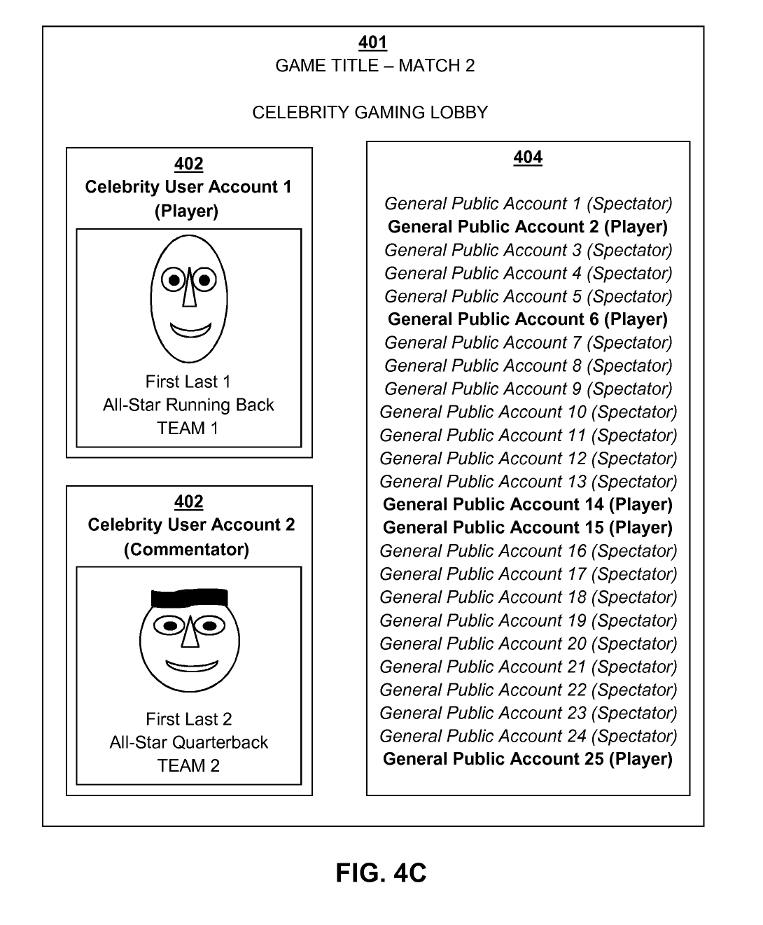

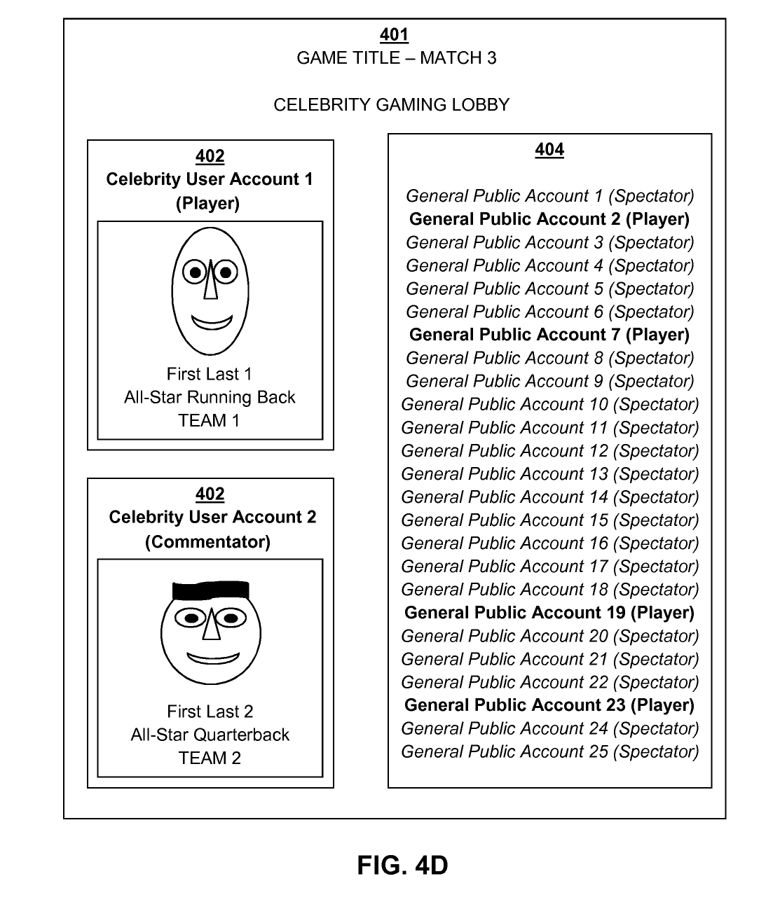

In some implementations, a specialized celebrity gaming lobby may be set up in order to host one or more celebrity gaming matches, an illustrative example of which is depicted in FIG. 4. As shown in FIG. 4, the celebrity gaming lobby 401 may have one or more celebrities 402 entered in the gaming lobby via their respective gaming network user accounts. One or more members of the general public 404 may be notified of one or more celebrity gaming matches associated with the celebrity gaming lobby 401. One or more of these notified users may request to participate in the celebrity gaming session via their respective gaming network user accounts. In certain implementations, each of the requesting users may be selected for entry into the celebrity gaming lobby, or only a subset of the requesting users may be selected for entry into the gaming lobby.

It is noted that utilizing a celebrity gaming lobby that is uniquely tailored to celebrity participation may provide certain benefits. For example, there may be a large number of general public users who wish to play or otherwise participate in gaming matches having celebrities as participants, e.g., there may be a large number of requests to participate in the celebrity gaming match from the general public user accounts. A specialized celebrity gaming lobby may allow the large number of requests to be handled in an optimized way. For example, since it may not be feasible for some gaming matches and gaming titles to allow every requesting member to participate in the celebrity gaming match, e.g., it may not be feasible to integrate such a large number of players into a single match, a celebrity gaming lobby that accounts for the distinction between celebrity user accounts and general public user accounts may be utilized to involve these users in other ways.

An illustrative example of how the celebrity gaming lobby may be further tailored to celebrity gaming is illustrated in FIGS. 4B-4C. For example, the general public users may request to participate in the at least one celebrity gaming match by requesting to enter a celebrity gaming lobby that has a plurality of gaming matches, e.g., in succession. In some, implementations, every general public user who requests to be a member of the lobby, or a large number of general public users who request to be a member of the lobby, may be entered into the celebrity gaming lobby that has one or more celebrities 402 as members. Then, for each celebrity gaming match of the lobby, only a subset of the general public user accounts 404 may be selected for participation. For example, only a subset of the general public user accounts 404 may be selected as players for a particular gaming match, as shown in FIG. 4B. Moreover, the general public user accounts which are selected as players for each match may change between matches, e.g., as shown in the example of FIGS. 4B-4D. By way of example, those general public user accounts which are selected as players or other participants may be changed between matches at random, or based on some other criteria. For example, if a general public user wins a match or otherwise achieves a favorable outcome, the general public user account may be rewarded by selecting the winning user account as a player in the next match.

Moreover, for each of the matches in the common celebrity gaming lobby, those users not selected as players may still be involved in other ways. For example, one or more of the non-player general public user accounts may be selected as spectators, and thus may still enjoy a video/audio stream of the match while waiting to be a player in a later match, as shown in FIG. 4B-4D. Thus, a large number of users may still be involved and engaged in the celebrity gaming and connected with the celebrities in a manner not possible with traditional gaming. Further still, in some implementations, for each match, one or more of the general public user accounts not selected as players may be selected as “meta-participants” and/or commentators, e.g., as described above with reference to FIG. 2.

Moreover, because the user accounts of the celebrities are distinguished in the online video game platform, they may be selected for the celebrity gaming matches in a different manner from the general public user accounts. For example, as shown in the example of FIGS. 4B-4D, the celebrity user accounts may be selected as participants in all of the matches for celebrity gaming lobby 401, while the general public user accounts can only play in some of the matches. In the illustrative example of FIGS. 4B-4D, celebrity user account 1 is selected as a player participant for every match of the celebrity gaming lobby, while celebrity user account 2 is selected as a commentator participant for every match of the celebrity gaming lobby. Further still, in certain implementations, the one or more celebrity user accounts 402 may be more prominently displayed in the celebrity gaming lobby, e.g., in a graphical user interface associated with the celebrity gaming lobby, as shown in FIGS. 4A-4D.

It is noted that traditional gaming lobbies are typically set up so that all the members of the lobby are players in the matches associated with the lobby. In the example gaming lobby of FIGS. 4A-4D, by contrast, less than all the members may be selected as players for one or more matches of the lobby, e.g., due to the unique ways in which video game users may be involved in online gaming matches and/or the unique distinction between restricted celebrity user accounts on the one hand, and general public user accounts on the other hand.

It is noted that aspects of an online gaming network configured to support celebrity gaming, e.g., aspects of the gaming network 100, may involve various online multiplayer gaming sessions between gaming users. For example, each of the gaming users, e.g., general public users 102 and celebrity users 104a-c may be associated with a user account that is maintained as part of a video game network, and each of the users may engage in online video game play through video game systems located remotely with respect to each other through a telecommunications network such as the internet. The users may participate in celebrity gaming by establishing a user account that may be maintained by the gaming network management 101. Gaming sessions between the users may be authenticated between the users through their corresponding user accounts, e.g., by logging into their corresponding user account through their local system.

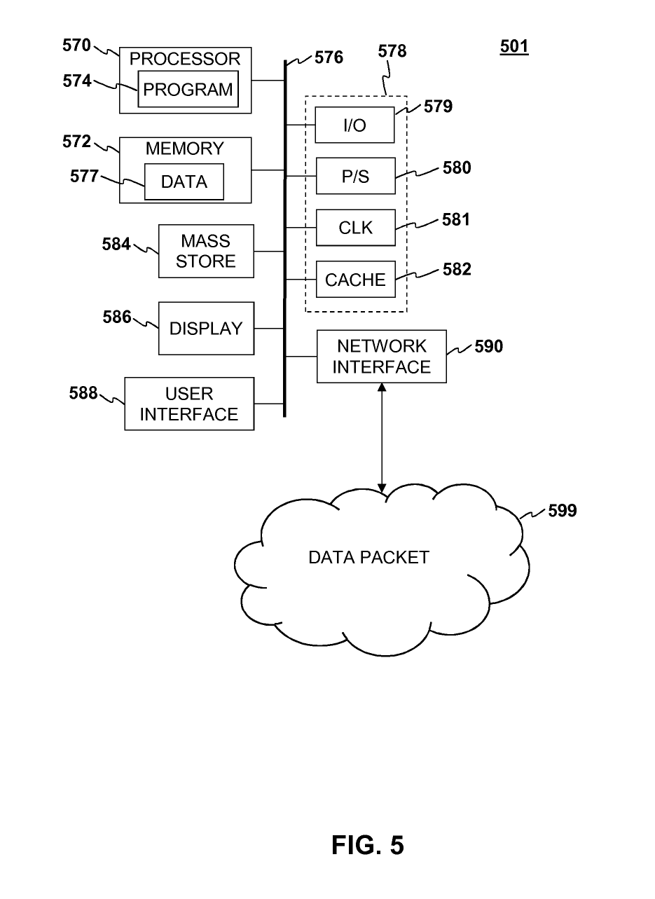

Various aspects of the present disclosure may be implemented through the Gaming Network Manager 211, which may include one or more servers. Such servers may be implemented by computing systems configured with suitable software and/or hardware to implement various aspects of the method 300 of FIG. 3. FIG. 5 depicts an illustrative computer system 501 configured to implementing one or more aspects of celebrity online gaming in accordance with the present disclosure. The system 501 may be a server or an embedded system, mobile phone, personal computer, tablet computer, portable game device, workstation, game console, and the like. In some implementations, the system 501 may be a cloud gaming server accessed remotely by gaming participants through respective client devices. For example, instead of a particular game being processed on each users local device, in some implementations gaming computations may be offloaded entirely to a remote system, such as system 501, which is remote from each users' respective client device, and the match participants and other users may interact with the game through any suitable interface and network connection of their local device. In some implementations, this may allow any internet enabled device to participate in gaming aspects that may, e.g., be designed for a gaming console or other specialize system.

The system 501 may include one or more processor units 570, which may be configured according to well-known architectures, such as, e.g., single-core, dual-core, quad-core, multi-core, processor-coprocessor, cell processor, and the like. The system 501 may also include one or more memory units 572 (e.g., RAM, DRAM, ROM, and the like). The processor unit 570 may execute one or more programs 574, portions of which may be stored in the memory 572, and the processor 570 may be operatively coupled to the memory 572, e.g., by accessing the memory via a data bus 576. The memory unit 572 may include data 577, and the processor unit 570 may utilize the data 577 in implementing the program 574. The data 577 may include, e.g., information regarding core game play as well as general user and celebrity account data according to various aspects of the present disclosure. The program 574 may include instructions that, when executed by a processor, perform one or more operations associated with a celebrity video game session, such as, e.g., a method having one or more features in common with the method 300 of FIG. 3.

The system 501 may also include well-known support circuits 578, such as input/output (I/O) circuits 579, power supplies (P/S) 580, a clock (CLK) 581, and cache 582, which may communicate with other components of the system, e.g., via the bus 576. The system 501 may optionally include a mass storage device 584 such as a disk drive, Blu-ray, DVD or CD-ROM drive, tape drive, flash memory, or the like, and the mass storage device 584 may store programs and/or data. The system 501 may also optionally include a display unit 586. The display unit 586 may be in the form of a cathode ray tube (CRT), flat panel screen, touch screen, or other device that displays text, numerals, graphical symbols, or other visual objects. The system 501 may also include a user interface 588 to facilitate interaction between the system 501 and a user. The user interface 588 may include a keyboard, mouse, light pen, game control pad, touch interface, or other device. The user interface may also include an audio I/O device, such as a speaker and/or microphone. For example, a headset peripheral device may optionally be included to provide inputs and/or outputs for associated with commentary for a celebrity gaming match in accordance with aspects of the present disclosure.

A user, such as, e.g., a video game player, may participate in celebrity gaming by interacting with the computer system through the user interface 588. Portions of the user interface 588 may include a graphical user interface (GUI) that can be displayed on the display unit 586 in order to facilitate user interaction with the system 501. The system 501 may include a network interface 590, configured to enable the use of Wi-Fi, an Ethernet port, or other communication methods. The network interface 590 may incorporate suitable hardware, software, firmware or some combination thereof to facilitate communication via a telecommunications network. The network interface 590 may be configured to implement wired or wireless communication over local area networks and wide area networks such as the Internet. The system 501 may send and receive data and/or requests for files via one or more data packets 599 over a network. The data 599 transmitted over the network may include any data that facilitates implementation of a celebrity gaming in accordance with the present disclosure, such as, e.g., gaming inputs, account authentication information, video/audio streaming feeds, and the like. The data 599 sent over the network may be exchanged or accessed by another network connected computer system (not pictured) in order to implement aspects of the present disclosure in a distributed computing environment over a network. These components may be implemented in hardware, software, firmware, or some combination thereof.

While the above is a complete description of the various illustrative implementations of the present disclosure, it is possible to use various alternatives, modifications and equivalents. Therefore, the scope of the present invention should not be construed to be limited by the above description but should, instead, be determined with reference to the appended claims, along with their full scope of equivalents. Any feature described herein, whether preferred or not, may be combined with any other feature described herein, whether preferred or not. In the claims that follow, the indefinite article “a”, or “an” refers to a quantity of one or more of the item following the article, except where expressly stated otherwise. The appended claims are not to be interpreted as including means-or-step-plus-function limitations, unless such a limitation is explicitly recited in a given claim using the phrase “means for” or “step for.”

What is claimed is:

1. A method comprising:
notifying a plurality of general public video game users of at least one online celebrity gaming match, the online celebrity gaming match having at least one celebrity participant;
receiving at least one request to participate in the online celebrity gaming match from at least one requesting user, the at least one requesting user being at least one of the general public video game users;
selecting, as at least one general public participant, at least one of the requesting users for participation in the online celebrity gaming match; and
authorizing, for each of the participants, interactive access to the at least one celebrity gaming match through authentication with a corresponding user account for each of the participants,
wherein said authorizing the interactive access includes authorizing the interactive access for each of the celebrity participants through authentication with a corresponding celebrity user account, each said celebrity user account being restricted to a verified celebrity whose celebrity identity has been previously verified.

2. The method of claim 1, further comprising:
hosting the online celebrity gaming match on at least one computing device.

3. The method of claim 1, further comprising:
hosting the online celebrity gaming match on at least one computing device, establishing a live communication channel between the general public participant and the celebrity participant during the online celebrity gaming match.

4. The method of claim 1, further comprising:
hosting the online celebrity gaming match on at least one computing device,
establishing a live video communication channel between the general public participant and the celebrity participant during the online celebrity gaming match.

5. The method of claim 1, further comprising:
hosting the online celebrity gaming match on at least one computing device,
establishing a live audio communication channel between the general public participant and the celebrity participant during the online celebrity gaming match.

6. The method of claim 1,
wherein the general public participant includes at least one general public player of the online celebrity gaming match.

7. The method of claim 1,
wherein the celebrity participant includes at least one celebrity player of the online celebrity gaming match.

8. The method of claim 1,
wherein the general public participant includes at least one general public commentator of the online celebrity gaming match.

9. The method of claim 1,
wherein the celebrity participant includes at least one celebrity commentator of the online celebrity gaming match.

10. The method of claim 1,
wherein the general public participant includes at least one general public player of the online celebrity gaming match,
wherein the celebrity participant includes at least one celebrity player of the online celebrity gaming match,
wherein the online celebrity gaming match is a gaming match which includes cooperative gaming between the general public player and the celebrity player.

11. The method of claim 1,
wherein the general public participant includes at least one general public player of the online celebrity gaming match,
wherein the celebrity participant includes at least one celebrity player of the online celebrity gaming match,
wherein the online celebrity gaming match is a gaming match which includes competitive gaming of the general public player against the celebrity player.

12. The method of claim 1,
wherein the at least one celebrity participant includes at least one celebrity athlete, at least one celebrity actor, at least one celebrity musician, or a combination thereof.

13. The method of claim 1,
wherein the at least one celebrity participant includes at least one celebrity athlete,
wherein the online celebrity gaming match involves a sports video game having a virtual version of the celebrity athlete,
wherein the celebrity user account corresponding to the celebrity athlete has priority to select control the virtual version of the celebrity athlete during the online celebrity gaming match.

14. The method of claim 1,
wherein the at least one celebrity participant includes at least one celebrity actor,
wherein the online celebrity gaming match involves a video game that is based on a movie or television show in which the celebrity actor portrays a character,
wherein the celebrity user account corresponding to the celebrity actor has priority to select control of the virtual version of the character of the television show or movie during the online celebrity gaming match.

15. The method of claim 1, further comprising:
broadcasting the online celebrity gaming match to a plurality of general public spectators.

16. The method of claim 1, further comprising:
broadcasting the online celebrity gaming match to a plurality of general public spectators,
wherein said broadcasting the online celebrity gaming match includes providing a live video feed of the online celebrity gaming match to one or more video receiving devices.

17. The method of claim 1, further comprising:
broadcasting the online celebrity gaming match to a plurality of general public spectators,
wherein said broadcasting the online celebrity gaming match includes providing a live video feed of the online celebrity gaming match to one or more video receiving devices,
wherein said providing the live video feed of the online celebrity gaming match includes providing, through an online video game network associated with said user accounts, access to the live video feed to at least one general public spectator authenticated with at least one general public user account.

18. The method of claim 1, further comprising:
recording a video of the online celebrity gaming match,
making the video available online after the match.

19. The method of claim 1, further comprising:
hiding a username of the celebrity user account from the general public users,
revealing the username of the celebrity user account to the general public participant.

20. The method of claim 1,
wherein said at least one requesting user is a plurality of requesting users,
wherein said selecting the at least one of the requesting users as the at least one general public participant includes selecting the at least one of the requesting users from the plurality of requesting users at random.

21. The method of claim 1, further comprising:
setting up at least one celebrity gaming lobby for the at least one celebrity gaming match,
wherein said celebrity gaming lobby further includes a plurality of other celebrity gaming matches, each said other celebrity gaming match having the at least one celebrity participant.

22. The method of claim 1, further comprising:
setting up at least one celebrity gaming lobby for the at least one celebrity gaming match,
wherein the celebrity gaming lobby further includes a plurality of other celebrity gaming matches, each said other celebrity gaming match having the at least one celebrity participant,
wherein the celebrity gaming lobby includes a plurality of said general public users as members of the celebrity gaming lobby,
wherein, for each said celebrity gaming match, only a subset of the plurality of general public users are selected as players.

23. The method of claim 1, further comprising:
setting up at least one celebrity gaming lobby for the at least one celebrity gaming match,
wherein the celebrity gaming lobby further includes a plurality of other celebrity gaming matches, each said other celebrity gaming match having the at least one celebrity participant,
wherein the celebrity gaming lobby includes a plurality of said general public users as members of the celebrity gaming lobby,
wherein, for each said celebrity gaming match, only a subset of the plurality of general public users are selected as players,
wherein the subset of the plurality of general public users selected as players changes between the celebrity gaming matches of the lobby.

24. The method of claim 1, further comprising:
setting up at least one celebrity gaming lobby for the at least one celebrity gaming match,
wherein the celebrity gaming lobby further includes a plurality of other celebrity gaming matches, each said other celebrity gaming match having the at least one celebrity participant,
wherein the celebrity gaming lobby includes a plurality of said general public users as members of the celebrity gaming lobby,
wherein, for each said celebrity gaming match, only a subset of the plurality of general public users are selected as general public players,
wherein the at least one celebrity participant is selected as at least one celebrity player for all of the celebrity gaming matches in the lobby.

25. The method of claim 1, further comprising:
setting up at least one celebrity gaming lobby for the at least one celebrity gaming match,
wherein the celebrity gaming lobby further includes a plurality of other celebrity gaming matches, each said other celebrity gaming match having the at least one celebrity participant,
wherein the celebrity gaming lobby includes a plurality of said general public users as members of the celebrity gaming lobby,
wherein, for each said celebrity gaming match, only a subset of the plurality of general public users are selected as general public players,
wherein, for each said celebrity gaming match, at least one of the general public users not selected as a general public player is selected as a spectator.

26. The method of claim 1, further comprising:
integrating live commentary from one or more of the participants into the celebrity gaming match.

27. The method of claim 1,
wherein said at least one requesting user is a plurality of requesting users,
wherein said receiving the at least one request includes receiving compensation from the plurality of requesting users in conjunction with each of the requesting users requests to participate in the online celebrity gaming match,
wherein said selecting the at least one of the requesting users as the at least one general public participant includes selecting a subset of the plurality of requesting users as the at least one general public participant,
wherein the method further comprises donating at least some of the compensation to at least one non-profit entity.

28. The method of claim 1,
wherein said at least one requesting user is a plurality of requesting users,
wherein said receiving the at least one request includes receiving compensation from the plurality of requesting users in conjunction with each of the requesting users requests to participate in the online celebrity gaming match,
wherein said selecting the at least one of the requesting users as the at least one general public participant includes selecting a subset of the plurality of requesting users as the at least one general public participant,
wherein the method further comprises donating at least some of the compensation to at least one non-profit entity,
wherein said at least some of the compensation is all net proceeds from the compensation.

29. The method of claim 1,
wherein said at least one requesting user is a plurality of requesting users,
wherein said receiving the at least one request includes receiving money from the plurality of requesting users in conjunction with each of the requesting users requests to participate in the online celebrity gaming match,
wherein said selecting the at least one of the requesting users as the at least one general public participant includes selecting a subset of the plurality of requesting users as the at least one general public participant,
wherein the method further comprises donating at least some of the money to at least one non-profit entity.

30. The method of claim 1,
wherein said at least one requesting user is a plurality of requesting users,
wherein said receiving the at least one request includes receiving a redemption of metagame reward points from the plurality of requesting users in conjunction with each of the requesting users requests to participate in the online celebrity gaming match,
wherein said selecting the at least one of the requesting users as the at least one general public participant includes selecting a subset of the plurality of requesting users as the at least one general public participant,
wherein the method further comprises donating an amount of money corresponding to a pre-determined worth of the metagame rewards points to at least one non-profit entity.

31. The method of claim 1, further comprising:
broadcasting the celebrity gaming match on a television network or internet video streaming network.

32. The method of claim 1, further comprising:
broadcasting the celebrity gaming match on a sports television network which specializes in sports broadcasting,
wherein the celebrity gaming match involves a sport video game.

33. The method of claim 1,
wherein said at least one requesting user is a plurality of requesting users,
wherein said receiving the at least one request includes receiving compensation from the plurality of requesting users via a purchase of a good required in conjunction with each of the requesting users requests to participate in the online celebrity gaming match,
wherein said selecting the at least one of the requesting users as the at least one general public participant includes selecting a subset of the plurality of requesting users as the at least one general public participant,
wherein the method further comprises donating at least some of the compensation to at least one non-profit entity.

34. A computing system comprising:
at least one processor unit;
at least one memory unit coupled to the at least one processor unit;
wherein the at least one processor unit and the at least one memory unit are configured to cause the computing system to perform a method, the method comprising:
notifying a plurality of general public video game users of at least one online celebrity gaming match, the online celebrity gaming match having at least one celebrity participant;
receiving at least one request to participate in the online celebrity gaming match from at least one requesting user, the at least one requesting user being at least one of the general public video game users;
selecting, as at least one general public participant, at least one of the requesting users for participation in the online celebrity gaming match; and
authorizing, for each of the participants, interactive access to the at least one celebrity gaming match through authentication with a corresponding user account for each of the participants,
wherein said authorizing the interactive access includes authorizing the interactive access for each of the celebrity participants through authentication with a corresponding celebrity user account, each said celebrity user account being restricted to a verified celebrity whose celebrity identity has been previously verified.

35. A non-transitory computer readable medium having computer readable instructions embodied therein, the computer readable instructions being configured to implement a method when executed, the method comprising:
notifying a plurality of general public video game users of at least one online celebrity gaming match, the online celebrity gaming match having at least one celebrity participant;
receiving at least one request to participate in the online celebrity gaming match from at least one requesting user, the at least one requesting user being at least one of the general public video game users;
selecting, as at least one general public participant, at least one of the requesting users for participation in the online celebrity gaming match; and
authorizing, for each of the participants, interactive access to the at least one celebrity gaming match through authentication with a corresponding user account for each of the participants,
wherein said authorizing the interactive access includes authorizing the interactive access for each of the celebrity participants through authentication with a corresponding celebrity user account, each said celebrity user account being restricted to a verified celebrity whose celebrity identity has been previously verified.
